(19) United States
(12) Patent Application Publication
(10) Pub. No.: US 2008/0060015 A1
(43) Pub. Date: Mar. 6, 2008

(54) Digital Broadcast Reception System

(76) Inventors: KAZUNORI IWABUCHI, Yokohama (JP); Koji Kamogawa, Yokohama (JP); Yoshifumi Izumi, Fujisawa (JP); Yasuo Egoshi, Zama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/850,082

(22) Filed: Sep. 5, 2007

(30) Foreign Application Priority Data
Sep. 5, 2006 (JP) 2006-239722

(51) Int. Cl. G06F 3/00

(52) U.S. Cl. 725/54

(57) ABSTRACT

A digital broadcast reception system includes: a digital tuner unit including a broadcast wave decoder, for decompressing a compressed digital broadcast wave for moving pictures, and a video scale converter, for reducing an image size provided by the decoded broadcast wave; and a transmission interface unit to be connected to the PC, wherein digital broadcasting images are transmitted via the transmission interface unit to enable the viewing of a digital broadcast. Thus, a digital broadcast reception system appropriate for a small information processing system, such as a notebook PC can be provided.

### INCORPORATION BY REFERENCE

The present application claims priority from Japanese application JP2006-239722 filed on Sep. 5, 2006, the content of which is hereby incorporated by reference into this application.

### BACKGROUND OF THE INVENTION

1. Field of the Invention

The present invention relates to a configuration method, for a digital broadcast reception system that views, records and reproduces moving picture information transmitted via a digital broadcasting wave, and that employs a tuner unit and a recording/reproduction system as subsystems. Particularly, the present invention relates to a digital broadcast reception system wherein a recording/reproduction system is a PC (personal computer).

2. Description of the Related Art

There is a digital broadcast reception system wherein a tuner unit is provided as a separate subsystem and a PC is connected to the tuner unit. This digital broadcast reception system is described, for example, in Japanese Patent Application Laid-Open No. 2006-74686.

According to the technique disclosed in Japanese Patent Application Laid-Open No. 2006-74686, a tuner unit and a PC are connected by a transmission interface in order to perform mutual authentication, and a transport stream output by the tuner unit is encrypted in the original form and the encrypted stream is transmitted to the transmission interface. In this manner, the copyright of a digital broadcasting program is protected.

### SUMMARY OF THE INVENTION

However, according to the technique described in Japanese Patent Application Laid-Open No. 2006-74686, since a transport stream obtained by multiplexing broadcasting program information is transmitted directly to the transmission interface, there is a probability that the transmission band for the transmission interface will run short.

Furthermore, in order to protect the copyright of a broadcasting program, authentication data included in the broadcasting wave must be employed by the PC. Therefore, the authentication data is not closed by the subsystem, and is easily analyzed.

Further, a broadband broadcast program decoding capability is provided for PCs, and it is predicted that the CPU usage rate for PCs will be high.

In addition, no consideration is given to the recording or reproduction of a broadcast program, nor to protection of the copyright for a recorded program.

Moreover, no consideration is given to a method for receiving a data broadcast wave that has been multiplexed.

Also, no consideration is given to a remote controller using infrared rays that are commonly employed for a digital broadcast reception system.

Furthermore, no consideration is given to the usability of a digital broadcast reception system when a PC is disconnected from a tuner unit.

Further, a case wherein a different type of tuner is employed is not taken into account.

In addition, a case wherein a different type of transmission interface is employed is not taken into account.

One objective of the present invention is to provide a digital broadcast reception system that resolves the above described conventional shortcomings, and that is appropriate for a small information processing system, such as a notebook PC.

In order to achieve the objective, according to the present invention, a digital broadcast reception system that, through a connection to a PC, enables use of the PC to view a digital broadcast comprises:

a digital tuner unit including

a broadcast wave decoder for decompressing a compressed digital broadcast wave for moving pictures, and

a video scale converter for reducing an image size provided by the decoded broadcast wave; and

a transmission interface unit to be connected to the PC,

whereby digital broadcasting images are transmitted via the transmission interface unit to enable the viewing of a digital broadcast.

Further, for the digital broadcast reception system of the present invention, the digital tuner unit includes a digital tuner and a broadcasting wave decoder, and the transmission interface unit transmits to the PC video data obtained by decoding.

According to the present invention, since the functions of the tuner unit and the PC can optimally be separated, a digital broadcast reception system can be provided that is especially appropriate for a small information processing system, such as a notebook PC. Thus, the present invention can contribute to popularization of the digital broadcasting system.

Other objects, features and advantages of the invention will become apparent from the following description of the embodiments of the invention taken in conjunction with the accompanying drawings.

### BRIEF DESCRIPTION OF THE DRAWINGS

FIG. 1 is a configuration diagram for a digital broadcast reception system according to a first embodiment of the present invention;

FIG. 2 is an exterior view of the digital broadcast reception system according to the first embodiment;

FIG. 3 is an internal block diagram for a PC according to the first embodiment;

FIG. 4 is an explanatory diagram for a band reduction method according to a second embodiment of the present invention;

FIG. 5 is an explanatory diagram for a band reduction method according to a third embodiment of the present invention;

FIG. 6 is an internal block diagram for a digital broadcast reception system according to the third embodiment;

FIG. 7 is an internal block diagram for a digital broadcast reception system according to a fourth embodiment of the present invention;

FIG. 8 is an exterior view of the digital broadcast reception system according to the fourth embodiment;

FIG. 9 is a flowchart for the transmission interface connection monitoring processing performed according to a fifth embodiment of the present invention; and

FIG. 10 is a configuration diagram for a digital broadcast reception system according to a sixth embodiment of the present invention.

### DESCRIPTION OF THE EMBODIMENTS

According to the present invention, a tuner, a broadcasting wave decoder and a video scale converter are provided for a tuner unit, while a video data receiver and a video data display unit are provided for a PC, and a decoder for directly decoding a broadcasting wave is not present in the PC. Therefore, even a processor having a low performance can perform an operation for viewing a digital broadcast. The present invention will now be described in detail while referring to the accompanying drawings.

### First Embodiment

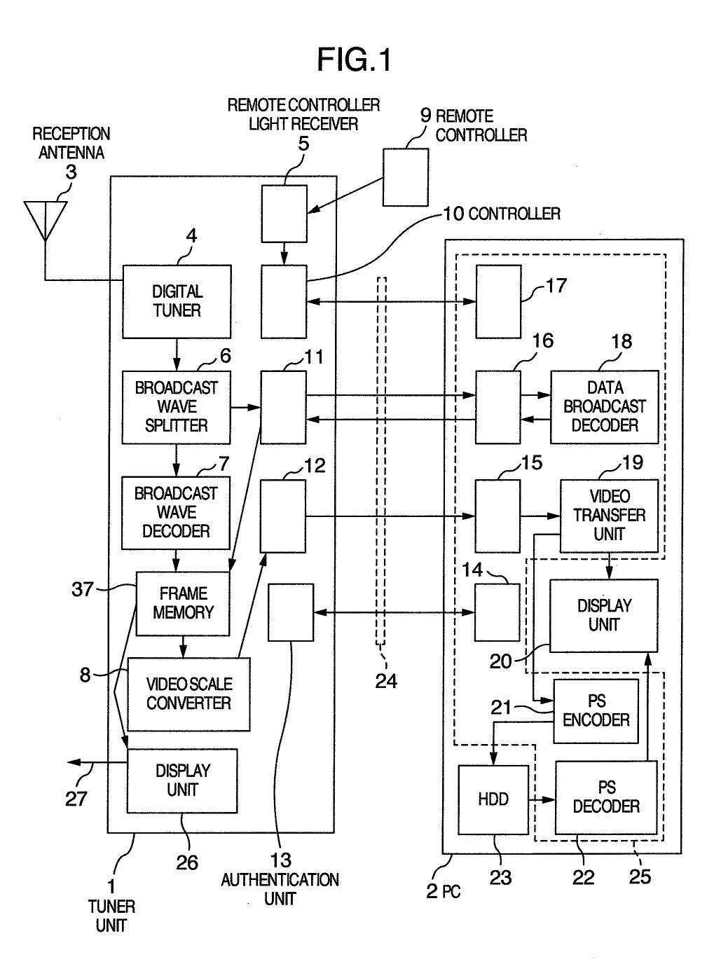

A first embodiment of the present invention will now be described while referring to FIGS. 1 to 3.

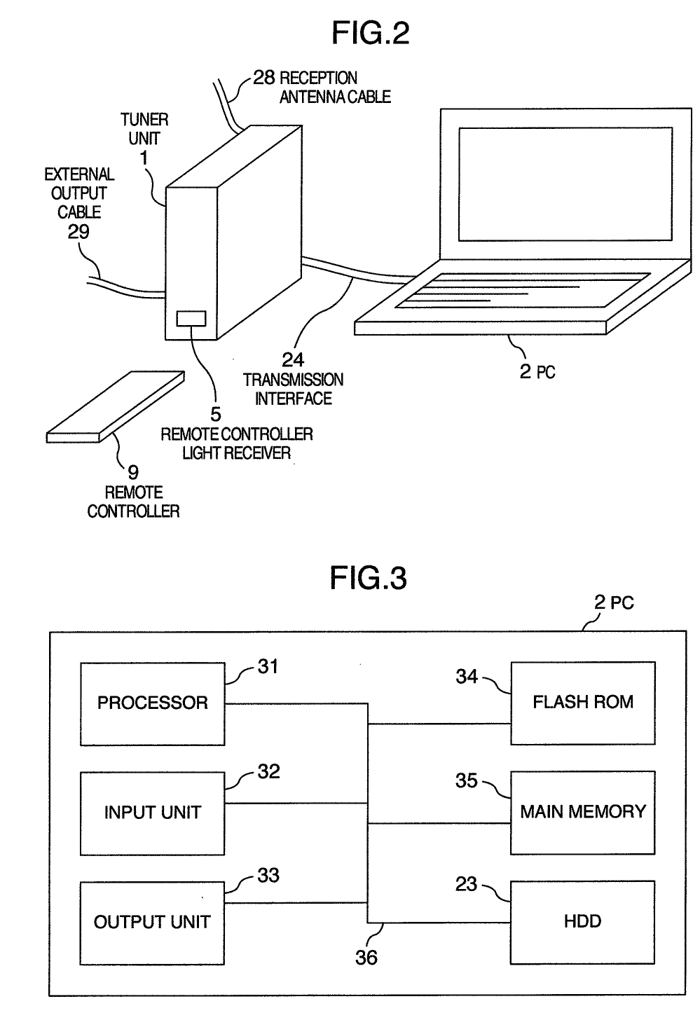

FIG. 1 is an internal block diagram for a digital broadcast reception system according to the first embodiment. The digital broadcast reception system comprises: 1 denotes a tuner unit, 2 denotes a PC, 3 denotes a reception antenna, 4 denotes a digital tuner, 5 denotes a remote controller light receiver, 6 denotes a broadcast wave splitter, 7 denotes a broadcast wave decoder, 8 denotes a video scale converter, 9 denotes a remote controller, 10 denotes a controller, 11 denotes an encryption/decryption unit, 12 denotes an encryption unit, 13 and 14 denote an authentication unit, 15 denotes a decryption unit, 16 denotes an encryption/decryption unit, 17 denotes a controller, 18 denotes a data broadcast decoder, 19 denotes a video transfer unit, 21 denotes a display unit, 21 denotes a PS encoder, 22 denotes a PS decoder, 23 denotes an HDD, 24 denotes a transmission interface, 25 denotes a digital broadcast reception control section, 26 denotes a display unit and 27 denotes an external output. FIG. 2 is an exterior view of the digital broadcast reception system. The tuner unit 1, the PC 2, a reception antenna cable 28, the remote controller light receiver 5, the remote controller 9, the transmission interface 24 and an external output cable 29 are provided.

While referring to the exterior view in FIG. 2, for the system of the first embodiment of the invention, the tuner unit 1 and the PC 2 are connected by the transmission interface 24, and the reception antenna cable 28 connected to the reception antenna 3 (shown in FIG. 1) and the external output cable 29 connected to the external output 27 are connected to the tuner unit 1. The tuner unit 1 includes the remote controller light receiver 5 that receives a control signal from the remote controller 9. The tuner unit 1, which serves as a peripheral device for the PC 2, is connected to the PC 2 by the transmission interface 24 and, with the PC 2, constitutes the digital broadcast reception system.

Referring again to FIG. 1, which is an internal block diagram for the tuner unit 1 and the PC 2 that constitute the digital broadcast reception system, the reception antenna 3 is connected to the tuner unit 1 to receive digital broadcasts. The reception antenna 3 is actually connected to the digital tuner 4 that separates a broadcast wave that includes a transport stream for digital broadcasting. The output terminal of the digital tuner 4 is connected to the broadcast wave splitter 6, which has a function for splitting a multiplexed stream unique to digital broadcasting. For the broadcast wave, the broadcast wave splitter 6 transmits to the broadcasting wave decoder 7 a video and audio information stream. Further, part of the output of the broadcast wave splitter 6 is transmitted as data-broadcast data to the encryption/decryption unit 11, which then encrypts the data and transmits the encrypted data to the encryption/decryption unit 16 of the PC 2. The encryption/decryption unit 16 decrypts the encrypted data-broadcast data and transmits the decrypted data to the data broadcast decoder 18. The data broadcast decoder 18 decodes the data-broadcast data, and obtains data-broadcast images. The data-broadcast images are returned to the encryption/decryption unit 16 and encrypted and the encrypted data are returned to the tuner unit 1, where they are decrypted by the encryption/decryption unit 11 and the decrypted data are stored in the frame memory 37. The broadcast wave output by the broadcast wave splitter 6 is transmitted to the broadcast wave decoder 7 and is stored as a video signal in the frame memory 37. The video signal stored in the frame memory 37 is transmitted to the video scale converter 8 and the display unit 26, and is output, as the external output 27, by the tuner unit 1. Furthermore, the scale of an image (the vertical and transverse size of an image) is reduced by the video scale converter 8, and video data is transmitted to the encryption unit 12. The encryption unit 12 encrypts the video data and transmits the encrypted video data to the PC 2. In the PC 2, the decryption unit 15 decrypts the video data and transmits the decrypted video data to the video transfer unit 19. Thereafter, the video transfer unit 19 transmits the video data to the display unit 20, which displays the images on the display device of the PC 2. Through the above described operation, the tuner unit 1 and the PC 2 of the digital broadcast reception system can display, on the display unit of the PC 2, the images carried in a digital broadcast received at the reception antenna 3.

The controller 17 of the PC 2 and the controller 10 of the tuner unit 1 exchange control signals and state information either to detect a connection that has been established or to control the overall system.

The remote controller light receiver 5 of the tuner unit 1 receives a control signal for a tuning operation designated by a user employing the remote controller 9, and transmits the control signal to the controller 10. The controller 10, which controls the entire tuner unit 1, transmits the tuning information to the digital tuner 4 to perform the tuning operation for a broadcasting station.

The authentication units 13 and 14 provided for the tuner unit 1 and the PC 2 authenticate each other, so that the digital broadcast reception system constituted by the tuner unit 1 and the PC 2 is provided as a uniform system.

The PC 2 includes the PS encoder 21 and the PS decoder 22 that handle a PS (program stream) format. The PS encoder 21 compresses video data received from the video transfer unit 19 to obtain compressed video data, and the compressed video data is stored on the HDD 23. In this manner, the recording of a broadcast program is performed. The broadcast program stored on the HDD 23 is transmitted to the PS decoder 22, and is decompressed to obtain video data, and the video data is transmitted to the display unit 20. In this manner, reproduction of the broadcast program is performed. Pursuant to the performance of this operation, the digital broadcast recording and reproduction function can be employed.

Further, video data for a broadcast wave and data-broadcast information are always encrypted and transmitted via the transmission interface 24 that connects the tuner unit 1 and the PC 2. Using the transmission interface 24, the tuner unit 1 and the PC 2 constitute a single system.

Instead of being transmitted directly from the tuner unit 1, a transport stream in a broadcast wave is decoded as video data by the broadcast wave decoder 7, and then, the image size for the decoded transport stream is reduced by the video scale converter 8 and the resultant transport stream is transmitted. Therefore, a smaller transmission band is required for the transmission interface 24 than when the transport stream is transmitted directly.

In the PC 2, the controller 17, the encryption/decryption unit 16, the decryption unit 15, the authentication unit 14, the data broadcast decoder 18, the video transfer unit 19, the PS encoder 21 and the PS decoder 22 are internally mounted as software modules in the digital broadcast reception control section 25.

FIG. 3 is an internal block diagram for the PC 2 shown in FIGS. 1 and 2. The PC 2 includes a processor 31, an input unit 32, an output unit 33, a flash ROM 34, a main memory 35, a system bus 36 and the HDD 23. Inside the PC 2 in FIG. 3, the processor 31 and the other individual components are connected by the system bus 36. When the PC 2 is powered on, a program in the flash ROM 34 is started, and an operating program on the HDD 23 is developed in the main memory 35 and is interpreted and executed by the processor 31.

The program that is mounted as the digital broadcast reception control section 25 in FIG. 1 using a software module is also interpreted and executed by the processor 31, and is operated via the input unit 32 and the output unit 33. In this embodiment, the program is mounted using the software module; however, depending on the maker, a hardware module may be employed to mount the program. When the program is mounted using a software module, however, a general-purpose PC that does not include special hardware can also be employed to constitute a digital broadcast reception system.

### Second Embodiment

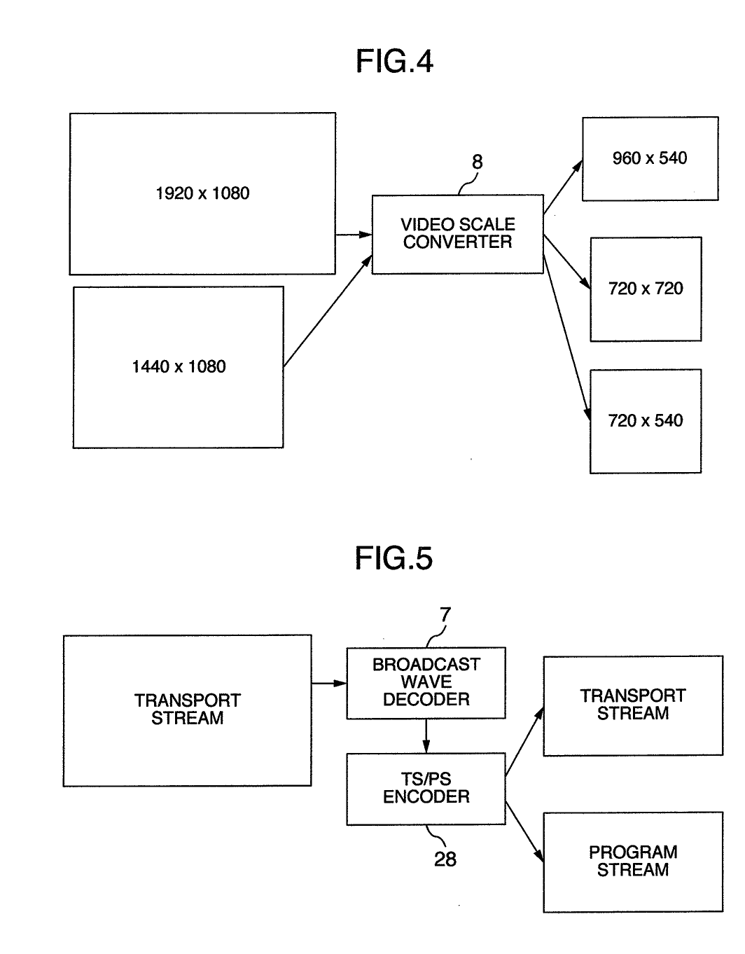

FIG. 4 is a diagram, according to a second embodiment of the present invention, for explaining the operation of a video scale converter 8 shown in FIG. 1. When the display size of video data is 1920×1080 dots, the video scale converter 8 reduces the video data, vertically and transversely, to half the size obtain with 960×540 dots. Furthermore, when the display size of video data is 1440×1080 dots, the video scale converter 8 reduces the video data, vertically and horizontally, to half the size obtained with 720×540 dots.

In this embodiment, an area ratio of one quarter has been described. However, so long as a small size and a satisfactory image quality can be maintained, 720×720 dots, for example, may be employed. For specific standards for video data, 520000 pixels or fewer is required, and thus, since either 960×540 dots or 720×720 dots is about 518000 pixels, a size that is thus obtained can provide a satisfactory quality. Specifically, as the characteristics of a 720×720 dot display into consideration, there are 600 or more vertical lines and transverse lines can not individually be distinguished because of the viewing characteristics of human eyes, and a not too high resolution is required. Therefore, there is very little deterioration in the quality.

### Third Embodiment

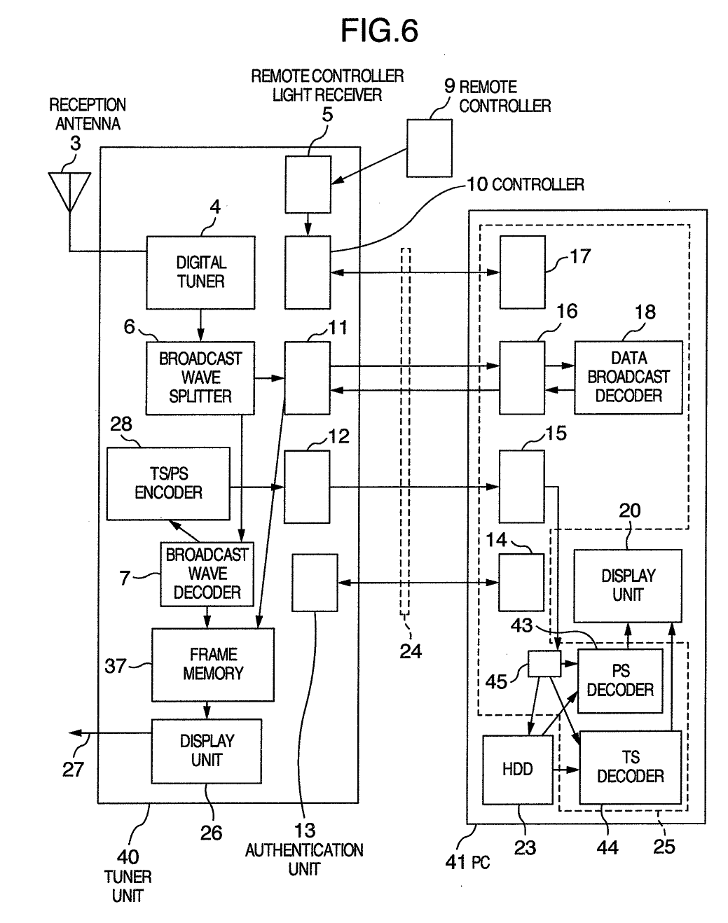

In FIG. 5, a TS/PS encoder 28 is employed instead of the video scale converter 8 in FIG. 1. Its detailed operation will be described later while referring to FIG. 6. The TS/PS encoder 28 employs different means from that used in the embodiments previously described, while referring to FIGS. 1 to 4, to reduce the size of a transmission band required by the transmission interface.

In this embodiment, a transport stream is transmitted, via a broadcasting wave decoder 7, to the TS/PS encoder 28, and is converted into a transport stream or a program stream having a smaller size in order to reduce the overall size of the band. Since a difference between the transport stream and the program stream is simply a difference in their formats, from the viewpoint of image quality, the transport stream and the program stream can be regarded as being the same.

FIG. 6 is an internal block diagram according to the third embodiment of the present invention, which employs the TS/PS encoder 28 explained in FIG. 5. Only a difference from FIG. 1, for the first embodiment, will be described. 28 denotes a TS/PS encoder, 40 denotes a tuner unit, 41 denotes a PC, 43 denotes a PS decoder, 44 denotes a TS decoder and 45 denotes a switching unit.

In the tuner unit 40, the TS/PS encoder 28 is connected to the succeeding stage of the broadcasting wave decoder 7, video data is encrypted by an encryption unit 12 and the encrypted information is transmitted to the PC 41. In the PC 41, the encrypted video data is received via a decryption unit 15, and is transmitted via the switching unit 45. For a viewing operation, the video data is transmitted via the PS decoder 43 or the TS decoder 44 to a display unit 20, and images are displayed on the display portion of the PC 41. For a recording operation, the video data is transmitted via the switching unit 45 and is stored as a recorded program on an HDD 23. For a reproduction operation, a recorded program stored on the HDD 23 is transmitted either to the PS decoder 43 or to the TS decoder 44, in accordance with its format, and is decoded as video data, and the decoded video data is transmitted to the display unit 20 and displayed.

A difference from the first embodiment is that instead of the video scale converter 8 in FIG. 1, the TS/PS encoder 28 is present in the tuner unit 40, and instead of the PS encoder 21, the TS decoder 24 is present in the PC 41. According to the third embodiment, since even though the TS/PS encoder 28 is expensive, the band that occupies the transmission interface 24 can be reduced and a PS encoder can be eliminated from the PC 41, and a more inexpensive processor having a lower performance can be employed for the processor in FIG. 3.

### Fourth Embodiment

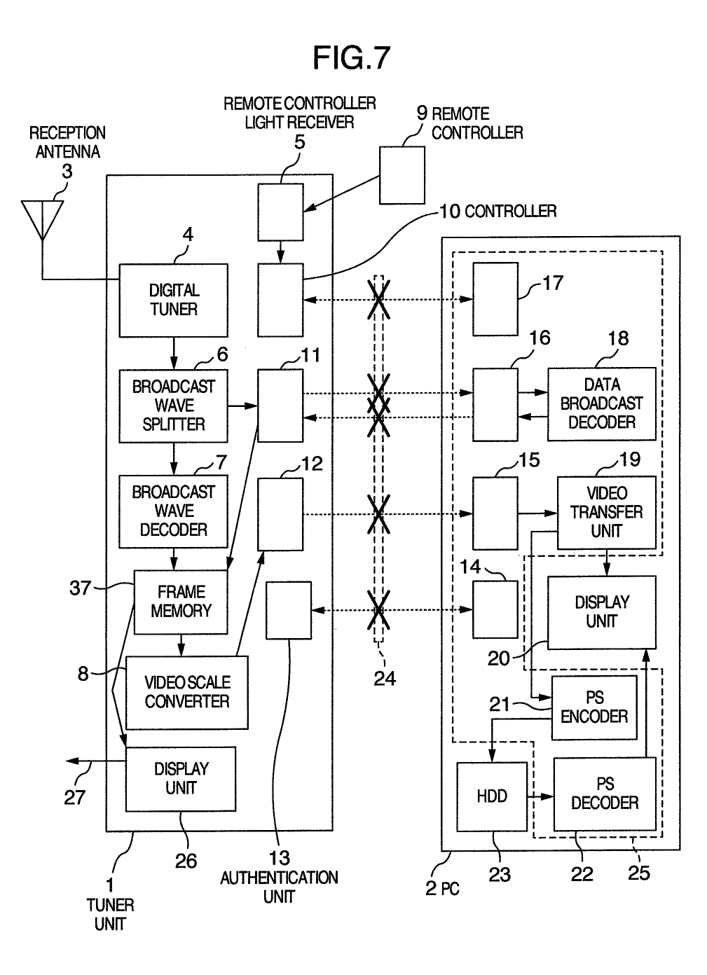

FIG. 7 is a diagram showing a digital broadcast reception system according to a fourth embodiment of the present invention. A difference from the digital broadcast reception system shown in FIG. 1 is that a transmission interface 24 is disconnected. In this state, since a tuner unit 1 and a PC 2 can not communicate with each other, control by the PC 2 and the functions of the PC 2 (decoding and viewing functions for data broadcasting, a recording function and a reproduction function) are disabled. However, since the tuner unit 1 can be operated using a remote controller 9, the tuner unit 1 can serve as an independent tuner for receiving a digital broadcast and display images.

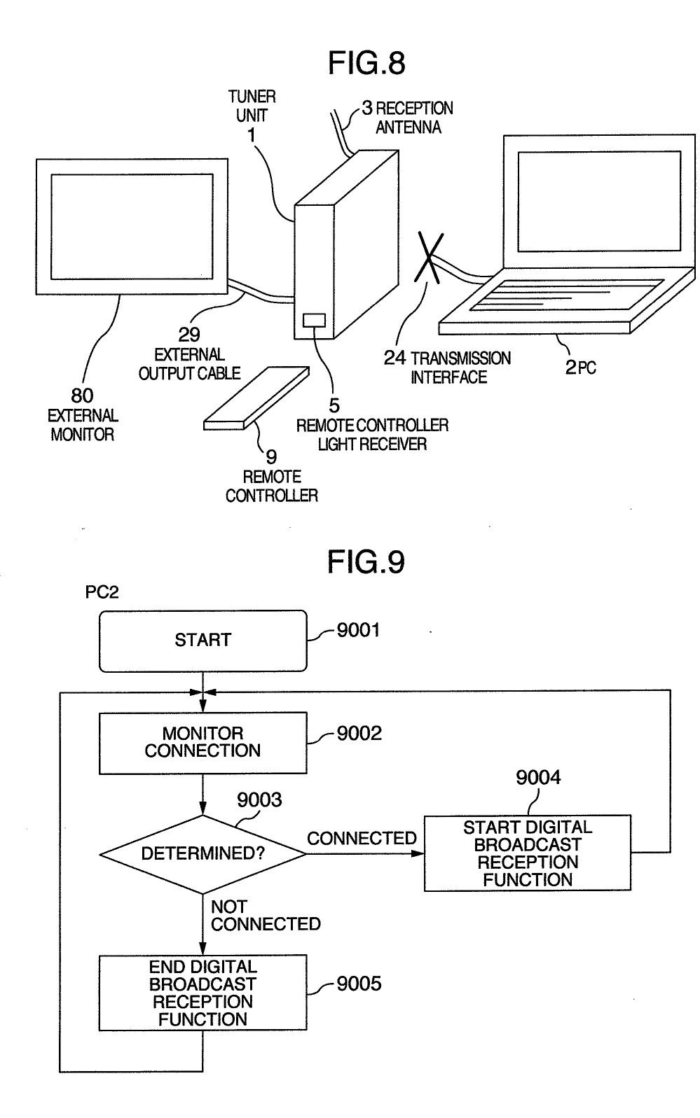

FIG. 8 is an exterior view for the fourth embodiment as described while referring to FIG. 7. Since the arrangement, other than an external monitor 80, is the same as that in FIG. 2, no further explanation will be given. In this case, the transmission interface 24 is not connected between the tuner unit 1 and the PC 2, while the external monitor 80 is connected to the tuner unit 1 via an external output cable 29. When the tuner unit 1 that is a peripheral device of the PC 2 is connected to the PC 2, the tuner unit 1 and the PC 2 constitute a digital broadcast reception system that can provide many functions, such as viewing, recording, reproduction and of broadcast data viewing. On the other hand, in this embodiment, such a level of usability is provided that, even when the transmission interface 24 is not connected, a digital broadcast viewing function is still enabled.

### Fifth Embodiment

FIG. 9 is a flowchart showing the operation performed when a transmission interface connection monitoring function for monitoring a connection of the transmission interface 24 is added as a program that is operated at the same time as the digital broadcast reception control section 25, which is a program module in the PC 2 of the fourth embodiment and was described while referring to FIGS. 7 and 8.

When the PC 2 is started, program control is shifted from 9001 to 9002, to monitor and determine whether the transmission interface 24 is connected. The monitoring process can be easily performed by employing the controller 17 or the authentication unit 13 in FIG. 1. Program control is shifted to 9003, and when, as the result of the monitoring, it is determined that the transmission interface 24 is connected, program control is shifted to 9004 and the digital broadcast reception function is performed by the digital broadcast reception control section 25. When it is determined that the transmission interface 24 has not yet been connected, the digital broadcast reception function of the digital broadcast reception control section 25 is ended. Through this process, a very convenient function is performed, i.e., when the transmission interface 24 is connected, all the functions provided by the digital broadcast reception system are automatically available, and even when the transmission interface 24 is not connected, the viewing of a digital broadcast is enabled.

### Sixth Embodiment

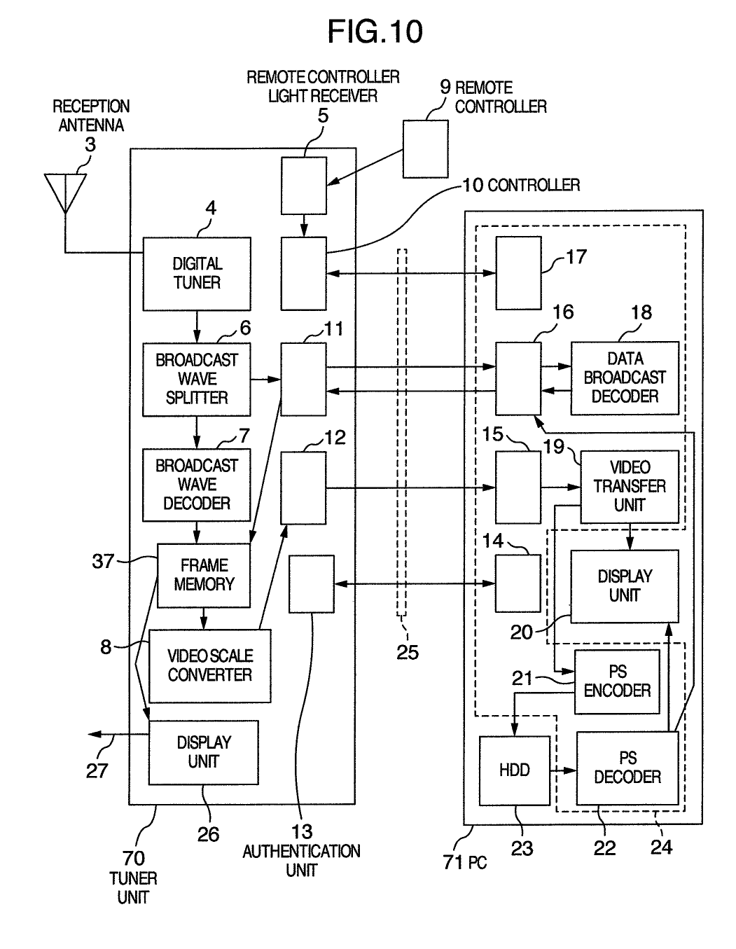

FIG. 10 is an internal block diagram for a sixth embodiment of the present invention, and only components that differ from those of the first embodiment, described while referring to FIG. 1, will be described. In FIG. 10, inside a PC 71, the output terminal of a PS decoder 24 is connected not only to a display unit 20, but also to an encryption/decryption unit 16. Data is encrypted by the encryption/decryption unit 16 and the encrypted data is transmitted to a tuner unit 70.

In the tuner unit 70, the data is decrypted by an encryption/decryption unit 11, and the decrypted data is stored as a video signal in a frame memory 37. The video data stored in the frame memory 37 is output as an output signal 27 by a display unit 26. In the first embodiment, when a recorded program stored on the HDD 23 is reproduced, the image data for the program can be displayed only on the display portion of the PC 71. However, in the sixth embodiment, the image data is transmitted to the tuner unit 70, so that reproduced images for the recorded program can also be displayed on an external monitor that is connected to the tuner unit 70. Therefore, the degree of completeness is higher as a digital broadcast reception system, and it is more convenient.

### Seventh Embodiment

For the digital broadcast reception systems of the embodiments described while referring to FIGS. 1 to 10, the transmission interface type has not especially been specified. The transmission interface type is not especially limited for the embodiments of the invention, and can be a wired interface, such as a USB (Universal Serial Bus) or an IEEE1394 or Ethernet (registered trademark) interface, or a wireless interface. Further, not only one interface, but also a separate interface for a video signal and control data may be employed, or a plurality of the same interfaces may be employed. When multiple interfaces are employed, a transmission band can be expanded, and a high quality image having a high resolution can be handled.

### Eighth Embodiment

For the digital broadcast reception systems of the embodiments described while referring to FIGS. 1 to 10, the type of broadcast wave that can be received is not especially specified. However, since the basic configuration of a digital broadcast does not differ greatly not only in the United States, Europe and Japan, but also in other countries, the digital broadcast wave is compatible, simply through practical application.

The digital broadcast reception system for each embodiment provides the following effects.

Since video data for a decompressed baseband is transmitted to the transmission interface, the transmission of video data is enabled at a constant data transfer rate that is not affected by the signal band of a broadcast wave, so that a stable data transfer can be performed.

Further, since the data size can be reduced by the video scale converter, a system can be provided wherein a band shortage does not occur.

Since the authentication unit is provided both for the tuner unit and the PC, a system independent of the broadcast wave authentication system can be employed to increase and reinforce the copyright protection provided by the entire system.

Furthermore, since the encryption unit is provided for the tuner unit and the decryption unit is provided for the PC, a general-purpose transmission interface can be employed.

In addition, since the broadcasting wave splitter and the broadcasting wave decoder are provided for the tuner unit, the CPU resources of the PC will not be consumed.

Moreover, since the broadcast program recording/reproduction mechanism is provided for the PC, a recording/reproduction system can be constituted instead of a simple reception apparatus, so that a more convenient system can be provided.

Also, since a data broadcast reception and viewing system is equipped with the PC, only a simple processor is required to constitute the tuner unit.

Further, when the remote controller light receiver is connected to the controller, the tuner unit can employ a remote controller to perform a tuning operation.

Furthermore, since the program stream encoder and the program stream decoder are provided for the PC, baseband video data received from the tuner unit can be compressed and stored on the hard disk of the PC. Further, a function for decoding this video data and displaying the data on the PC can be provided.

In addition, since the components of the PC are mounted as software units in the digital broadcast reception control section, the digital broadcast reception system can be easily constituted by the PC.

Moreover, since the recording/reproduction system is present in the PC, the transmission interface for the tuner unit is disconnected from the PC, and the recording/reproduction function can be operated by only the PC.

Also, since hardware inherent to digital broadcasting is mounted in the tuner unit, and since all the components of the PC are mounted using software modules, only a general-purpose PC is required.

It should be further understood by those skilled in the art that although the foregoing description has been made on embodiments of the invention, the invention is not limited thereto and various changes and modifications may be made without departing from the spirit of the invention and the scope of the appended claims.

1. A digital broadcast reception system, which enables viewing of a digital broadcast on a PC through a connection to the PC, comprising:
a digital tuner unit including
a broadcasting wave decoder for decompressing a compressed digital broadcasting wave for moving pictures, and
a video scale converter for reducing in size video data provided by the decoded broadcasting wave; and
a transmission interface unit to be connected to the PC,
wherein digital broadcasting images are transmitted to the PC, via the transmission interface unit, to enable displaying of a digital broadcast.

2. A digital broadcast reception system according to claim 1, further comprising:
an encryption unit for encrypting the video data, whose size is reduced by the video scale converter,
wherein encrypted digital broadcast images are transmitted to the PC, via the transmission interface unit, and the PC is able to display the digital broadcast.

3. A digital broadcast reception system according to claim 1, wherein the digital tuner unit includes a digital tuner and a broadcasting wave decoder, and the transmission interface unit transmits to the PC video data obtained by decoding.

4. A digital broadcast reception system according to claim 1, wherein the video scale converter performs scaling for decoded video data for a broadcast wave to obtain an image size having 960 dots vertically and 540 dots transversely.

5. A digital broadcast reception system according to claim 1, wherein the video scale converter performs scaling for decoded video data for a broadcast wave to obtain an image size having 720 dots vertically and 720 dots transversely.

6. A digital broadcast reception system according to claim 1, further comprising:
a data broadcast splitter for separating a data broadcast stream from a digital broadcast wave; and
a data broadcast encryption/decryption unit for encrypting the data broadcast stream and for decrypting data broadcast video data transmitted by the PC,
wherein the transmission interface unit connected to the PC transmits, to the PC, a digital broadcast stream that is separated from the digital broadcast wave by the data broadcast splitter and is encrypted by the data broadcast encryption/decryption unit, and receives, from the PC, data broadcast video data that is decoded based on the digital broadcast stream, and
wherein the video data, decoded based on the digital broadcast wave, and the data broadcast video data, received from the PC, are synthesized, and the resultant information is displayed.

7. A digital broadcast reception system according to claim 1, further comprising:
an authentication unit for authenticating the PC,
wherein the digital tuner unit and the PC are constituted as a uniform system.

8. A digital broadcast reception system according to claim 1, further comprising:
a remote control receiver for receiving operation information from a user; and
a display unit for outputting video data decoded by the broadcasting wave decoder,
wherein a digital broadcast is displayed based on the operation information received from the remote control receiver.

9. A digital broadcast reception system according to claim 1, further comprising:
a connection monitoring unit for monitoring a connection state for the transmission interface unit; and
an external image output unit for outputting, to an external display unit, video output of the digital tuner unit,
wherein, when the connection monitoring unit detects disconnection of the transmission interface unit, images are output by the external video output unit.

10. A digital broadcast reception system according to claim 1, further comprising:
an external video output unit for outputting, to an external display unit, video output of the digital tuner unit,
wherein a decoded data broadcast viewing screen is received from the PC via the transmission interface unit, the video output of the digital tuner unit and the data broadcast viewing screen are synthesized, and the resultant image is output by the external video output unit.

11. A digital broadcast reception system according to claim 1, further comprising:
an external video output unit for outputting, to an external display unit, video output of the digital tuner unit,
wherein video data obtained by decoding a program stream is obtained from the PC via the transmission interface unit, and is output by the external video output unit.

12. A digital broadcast reception system, which enables viewing of a digital broadcast on a PC through a connection to the PC, comprising:
a digital tuner unit including
a broadcast wave decoder for decompressing a compressed digital broadcast wave for moving pictures, and
a re-encoder for converting a transport stream for a decoded broadcasting wave into a program stream or a transport stream; and
a transmission interface unit to be connected to the PC,
wherein re-encoded digital broadcasting images are transmitted via the transmission interface unit to the PC to enable displaying of a digital broadcast.

13. A digital broadcast reception system according to claim 12, wherein the re-encoder re-encodes video data, so that when the video data is transmitted to the PC via the transmission interface unit, a band is reduced.

14. A digital broadcast reception system according to claim 12, further comprising:
a connection monitoring unit for monitoring a connection state for the transmission interface unit; and
an external image output unit for outputting, to an external display unit, video output of the digital tuner unit,
wherein, when the connection monitoring unit detects disconnection of the transmission interface unit, images are output by the external video output unit.

15. A digital broadcast reception system according to claim 12, further comprising:
an external video output unit for outputting, to an external display unit, video output of the digital tuner unit,
wherein a decoded data broadcast viewing screen is received from the PC via the transmission interface unit, the video output of the digital tuner unit and the data broadcast viewing screen are synthesized, and the resultant image is output by the external video output unit.

16. A digital broadcast reception system according to claim 12, further comprising:
an external video output unit for outputting, to an external display unit, video output of the digital tuner unit,
wherein video data obtained by decoding a program stream is obtained from the PC via the transmission interface unit, and is output by the external video output unit.

17. A digital broadcast reception system, which enables viewing of a digital broadcast on a PC through a connection to the PC, comprising:
a digital tuner unit including
a broadcast wave decoder for decompressing a compressed digital broadcast wave for moving pictures, and
a re-encoder for converting a transport stream for a decoded broadcasting wave into a program stream or a transport stream;
a transmission interface unit to be connected to the PC; and
a recorder incorporated in the PC to record video data to be received via the transmission interface unit,
wherein digital broadcasting images are transmitted to the PC, via the transmission interface unit, to enable recording of a digital broadcast in the recording unit.

18. A digital broadcast reception system according to claim 17, further comprising:
a decoder for decoding video data recorded in the recording unit,
wherein displaying of decoded video data is enabled.
